(19) United States
(12) Patent Application Publication
(10) Pub. No.: US 2006/0091740 A1
(43) Pub. Date: May 4, 2006

(54) Router heat sink system

(76) Inventors: Jason Porter Whitmire, Pledmont, SC (US); Kenneth M. Brazell, Pledmont, SC (US); Raymond Wal Man Wong, Vaucluse (AU); Sia Khiam Keong, Kowloon (HK)

Correspondence Address: BRINKS HOFER GILSON & LIONE, P.O. BOX 10395, CHICAGO, IL, 60610, US

(21) Appl. No.: 10/975,314

(22) Filed: Oct. 28, 2004

(51) Int. Cl. H02K 7/14

(52) U.S. Cl. 310/50; 310/64

(57) ABSTRACT

A trim router heat sink with a bearing seat and shaft lock that mount to a trim router to act as a heat sink. A shaft extends through the bearing seat and has a shaft lock. The shaft is held on one end by the trim router's motor shaft and on the other end by a bearing. The shaft is connected to a collet so that when the motor of the trim router is operated, the shaft turns the collet. The shaft can be locked to facilitate the installation or removal of a cutting tool in the collet.

### BACKGROUND

The present invention relates to a router heat sink system. More particularly, the present invention relates to a router heat sink that includes an integral bearing seat and shaft lock.

The motor shaft bearing of a router generates considerable heat during operation of the router. It is desirable to dissipate this heat to avoid overheating and possibly damaging the motor shaft bearing and motor which could result in shortening the lifespan of both the motor shaft bearing and motor. Traditional routers that may be powered by being connected to 120 volt alternating current power source, such as that found in the typical household or construction site, incorporate a fan to circulate air through the housing of the router. This is acceptable for traditional routers connected to 120 volt alternating current power source since there is no need to conserve power. However, battery operated routers have a finite amount of power available in any given battery pack. In a battery operated router, in order to maximize the amount of work that can be performed by a battery pack, it is desirable to conserve the battery power as much as possible and to have as much of the battery power as possible available for driving the router's motor. Therefore, it is not desirable to use a fan to cool the motor shaft bearing of the router since the fan increases the drain of power from the battery pack, thereby decreasing the amount of useful work that can be performed between charges.

Additionally, all routers, whether traditionally powered by 120 volt alternating current or by a direct current battery pack, have the inherent need of keeping the motor, motor shaft and collet aligned. This alignment need is even more pronounced in routers that have a plastic housing since the plastic housing may not be strong enough to provide a fixed support for the motor shaft and collet.

Finally, it is desirable to have a router with a shaft lock to facilitate the tightening and loosening of the collet when changing bits. In routers with a plastic housing, many difficulties are encountered in attempting to mount a shaft lock through the plastic body because the torque applied to the housing when the lock is engaged can deform the plastic housing.

### BRIEF SUMMARY

In accordance with the present invention, a router heat sink is provided. The router heat sink includes an integral bearing seat and shaft lock. The heat sink piece can be made of any type of heat conducting material known to those of skill in the art. In one embodiment, the heat sink is made of a die cast metal. In another embodiment, the heat sink is made of two pieces of die cast metal where the first heat sink piece can be fastened to the motor in contact with the motor shaft bearing and the second heat sink piece can be attached to the first. The first heat sink piece acts as a heat sink for the motor shaft bearing. The second heat sink piece is attached on its first end to the first heat sink piece and on its second end provides a bearing seat for housing an output shaft bearing. The second heat sink piece acts as a heat sink to the output shaft bearing and the motor shaft bearing. The output shaft bearing seat is dimensioned so that the output shaft bearing fits securely therein. Additionally, the second heat sink piece provides a hollow portion for a shaft lock to engage.

A output shaft extends through the two die cast pieces and the output shaft bearing. The output shaft connects to the motor at one end and to a collet and collet nut on the opposite end. The alignment of the output shaft with the motor and the collet is maintained by the output shaft bearing. Alternatively, the output shaft and the output shaft bearing can be constructed as a single assembly while retaining the same functionality.

The output shaft includes a hollow portion for engagement with a shaft lock. The shaft lock passes through the router housing and engages the hollow portion of the heat sink and the hollow portion of the output shaft thereby preventing rotation of the shaft. The shaft lock is held in place by a spring clip.

### BRIEF DESCRIPTION OF THE DRAWINGS

FIG. 1 is an exploded view of a router heat sink system and a router motor and router housing.

FIG. 2 is a perspective view of one embodiment of a router heat sink system adjacent to a router motor which is in turn installed in a router housing.

FIG. 3 is a perspective view one embodiment of a router heat sink system according to the present invention adjacent to a router motor.

### DESCRIPTION

Referring to the figures a router heat sink system 100 is shown. The router heat sink system 100 includes a router motor 110, a first heat sink piece 120, a second heat sink piece 130, a output shaft bearing 140, a output shaft 150, a shaft lock 160, and a collet assembly 170. The router motor 110 includes a base end 112 and an output end 114. The motor output end 114 includes a motor shaft bearing 116 and an motor shaft 118 for transferring the power of the motor 110 to the output shaft 150 which in turn is connected to the collet assembly 170 which holds a router bit, not shown. The router motor 110 can be any of a variety of battery operated motors capable of powering a router as is known to one skilled in the art.

The first heat sink piece 120 surrounds the motor shaft bearing 116 near the motor shaft 118 of the motor 110 and provides a heat sink for the motor shaft bearing 116. The first heat sink piece 120 has a first end 122 and a second end 124. The first end 122 is adjacent to the output end of the motor 114. The first heat sink piece 120 is secured to the motor 110 by any of a variety of fasteners. In one embodiment, the first heat sink piece 120 is secured to the motor 110 by a threaded fastener such as a screw or a bolt.

The second heat sink piece 130 is adjacent to the first heat sink piece 120 and provides a heat sink for the output shaft bearing 140 and an additional heat sink for the motor shaft bearing 116. The second heat sink piece has a first end 132 and a second end 134. The first end 132 is adjacent to the first heat sink piece second end 124. In another embodiment, the second heat sink piece 130 may be connected to the router motor 110. The second heat sink piece 130 is connected to the first heat sink piece 120 or the router motor 110 by any of a variety of fasteners. In one embodiment, the second heat sink piece 130 is secured to the first heat sink piece 120 by a threaded fastener such as a screw or a bolt. Additionally, an integral bearing seat 136 is formed on the second heat sink piece second end 134. The integral bearing seat 136 is dimensioned so that a output shaft bearing 140 can be secured therein. The second heat sink piece 130 has a shaft lock opening 138 that is located between the second heat sink piece first end 132 and the second heat sink piece second end 134. The shaft lock opening 138 is dimensioned so that when a shaft lock 160 is engaged through the shaft lock opening 138 and into the output shaft 150 the rotation of the output shaft 150, is prevented.

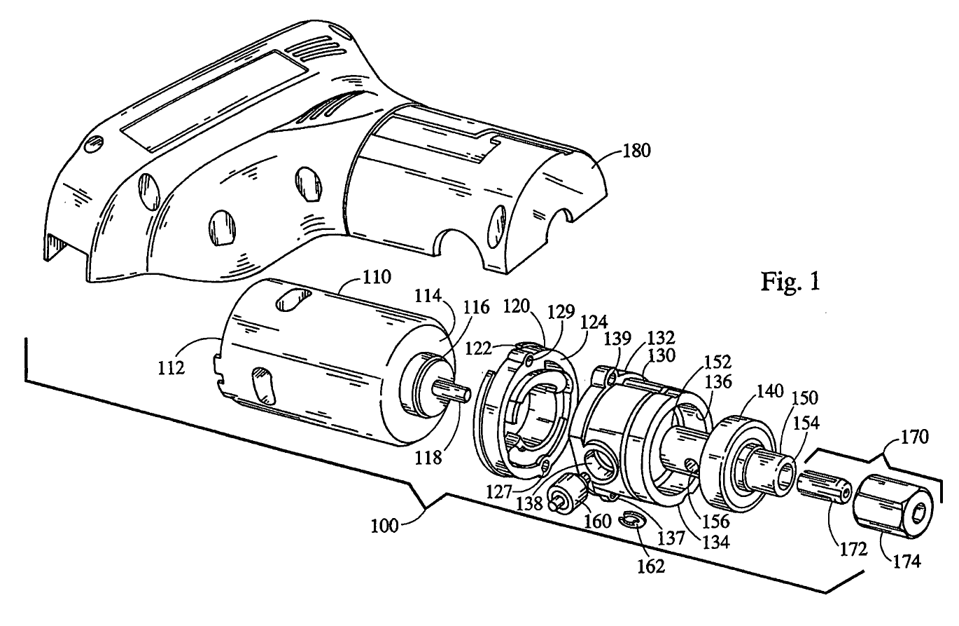

FIG. 1 also shows the attachment points 127, 129 on the first heat sink piece 120 and the attachment points 137, 139 on the second heat sink piece 130. The attachment points 127, 129, 137, 139 allow the first heat sink piece 120 and second heat sink piece 130 to be secured together.

The first heat sink piece 120 and second heat sink piece 130 can be made of any type of heat conducting material as is known to one of skill in the art. In one embodiment, the first heat sink piece 120 and second heat sink piece 130 are made of metal and can be a die cast metal. In another embodiment, the first heat sink piece 120 and second heat sink piece 130 can be made as a single piece structure rather than as a two piece structure.

As stated above, the output shaft bearing 140 fits into the integral bearing seat 136 and helps keep the output shaft 150 aligned with the motor shaft 118 of the motor 110. The output shaft bearing 140 can be any type of bearing capable of functioning at the speeds and loads that are common to routers as is known to one skilled in the art.

The output shaft 150 has a first end 152 and a second end 154 and contains a shaft lock opening 156 between the first end 152 and the second end 154. The first end 152 is operatively connected to the motor shaft 118. The second end 154 is connected to a collet assembly 170. The output shaft 150 is held in place near the second end 154 by the output shaft bearing 140. The shaft lock opening 156 is dimensioned so that when the shaft lock 160 is engaged, a portion of the shaft lock 160 protrudes into the shaft lock opening 156 and prevents the output shaft 150 from turning. The output shaft 150 can be constructed of any type of material capable of functioning at the speeds and loads that are common to routers. In one embodiment, the output shaft 150 is made of a metallic material. In another embodiment, the output shaft 150 and the output shaft bearing 140 can be made as a single piece assembly rather than as a two piece assembly.

The shaft lock 160 is dimensioned so that when it is disengaged the output shaft 150 can freely rotate. However, when the shaft lock 160 is engaged, the shaft lock 160 is aligned with the shaft lock openings 138 and 156 and protrudes into the shaft lock opening 156 to prevent the output shaft 150 from rotating. The shaft lock 160 can be constructed of any type of material capable of withstanding the torque imparted to it when it is engaged and the collet is loosened or tightened such as when the router bits are changed. Additionally, visible in FIG. 1 is the shaft lock retention device 162. The shaft lock retention device 162 attaches to the shaft lock 160 and prevents the shaft lock 160 from being unintentionally removed from the router housing 180.

FIG. 1 shows the collet 172 and the collet nut 174 which are both part of the collet assembly 170. When the shaft lock 160 is engaged the collet nut 174 can be tightened or loosened from the output shaft 150. When the collet nut 174 is tightened to the output shaft 150, the collet 172 is compressed and a router bit, not shown, can be held in place and rotated by the motor 110 through the motor's motor shaft 118 and the output shaft 150.

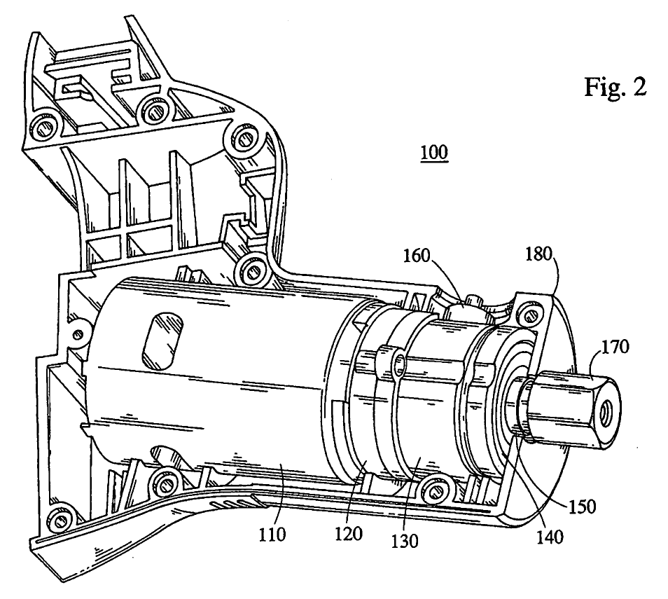

Turning now to FIG. 2, a perspective view of a router heat sink system 100 is shown. The router heat sink system 100 includes a router motor 110, a first heat sink piece 120, a second heat sink piece 130, a output shaft bearing 140, a output shaft 150, a shaft lock 160 a collet assembly 170 and a router housing 180.

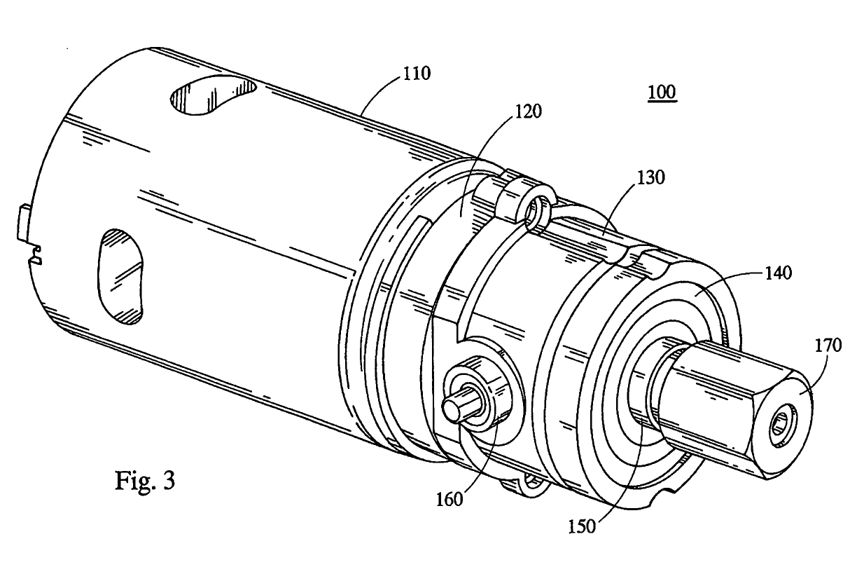

FIG. 3 shows a perspective view of a router heat sink system 100. The router heat sink system 100 includes a router motor 110, a first heat sink piece 120, a second heat sink piece 130, a output shaft bearing 140, a output shaft 150, a shaft lock 160, and a collet assembly 170.

It is therefore intended that the foregoing detailed description be regarded as illustrative rather than limiting, and that it be understood that it is the following claims, including all equivalents, that are intended to define the spirit and scope of this invention.

1. A router heat sink system comprising:
a. a router motor having a first end and a second end, the second end having a motor shaft bearing and a motor shaft;
b. an output shaft having a first end operatively connected to the motor shaft;
c. a heat sink piece operatively connected on a first end to the motor adjacent to the motor shaft bearing, the heat sink piece having an integral bearing seat on a second end; and
d. an output shaft bearing operatively connected to the integral bearing seat and operatively connected to the output shaft near a second end, wherein the heat sink piece conducts heat from the output shaft bearing and the motor shaft bearing.

2. The router heat sink system of claim 1 wherein the heat sink piece further comprises a first heat sink piece and a second heat sink piece, the first heat sink piece operatively connected on a first end to the router motor second end and the second heat sink piece operatively connected on a first end to a second end of the first heat sink piece.

3. The router heat sink system of claim 2 wherein the second heat sink piece is operatively connected to the router motor.

4. The router heat sink system of claim 1 wherein the heat sink piece further comprises a shaft lock opening.

5. The router heat sink system of claim 4 further comprising a shaft lock operatively connected to the heat sink piece and the output shaft, wherein in a first position rotation of the output shaft is prevented.

6. A router heat sink system comprising:
a. a router motor having a first end and a second end, the second end having a motor shaft bearing and a motor shaft;
b. an output shaft having a first end operatively connected to the motor shaft;
c. a first heat sink piece operatively connected on a first end to the motor adjacent to the motor shaft bearing;
d. a second heat sink piece, the second heat sink piece having a first end operatively connected to a second end of the first heat sink piece and an integral bearing seat on a second end of the second heat sink piece; and
e. an output shaft bearing operatively connected to the integral bearing seat and operatively connected to the output shaft near a second end, wherein the heat sink piece conducts heat from the output shaft bearing and the motor shaft bearing.

7. The router heat sink system of claim 6 wherein the second heat sink piece further comprises a shaft lock opening.

8. The router heat sink system of claim 7 further comprising a shaft lock operatively connected to the second heat sink piece and the output shaft and wherein in a first position rotation of the output shaft is prevented.

9. The router heat sink system of claim 6 wherein the second heat sink piece is operatively connected to the router motor.

10. A router heat sink system comprising:
a. a router motor having a first end and a second end, the second end having a motor shaft bearing and a motor shaft;
b. an output shaft having a first end operatively connected to the motor shaft;
c. a heat sink piece operatively connected on a first end to the motor adjacent to the motor shaft bearing, the heat sink piece having an integral bearing seat on a second end;
d. an output shaft bearing operatively connected to the integral bearing seat and operatively connected to the output shaft near a second end, wherein the heat sink piece conducts heat from the output shaft bearing and the motor shaft bearing; and
f. a shaft lock operatively connected to the heat sink piece and the output shaft and wherein in a first position rotation of the output shaft is prevented.

11. The router heat sink system of claim 10 wherein the heat sink piece further comprises a first heat sink piece and a second heat sink piece, the first heat sink piece operatively connected on a first end to the router motor second end and the second heat sink piece operatively connected on a first end to a second end of the first heat sink piece.

12. The router heat sink system of claim 11 wherein the second heat sink piece is operatively connected to the router motor.
